(19) United States
(12) Patent Application Publication
(10) Pub. No.: US 2011/0234114 A1
(43) Pub. Date: Sep. 29, 2011

(54) AC LED LIGHTING ELEMENT AND AC LED LIGHTING SYSTEM METHODS AND APPARATUS

(75) Inventors: Michael Miskin, Sleepy Hollow, IL (US); Charles Huber, Lake Forest (IL)

(73) Assignee: Lynk Labs, Inc., Elgin, IL (US)

(21) Appl. No.: 13/133,122

(22) PCT Filed: Dec. 7, 2009
(86) PCT No.: PCT/US09/06441

§ 371 Date: Jun. 6, 2011

Related U.S. Application Data
(60) Provisional application No. 61/200,999, filed on Dec. 5, 2008.

(51) Int. Cl. H05B 37/02

(52) U.S. Cl. 315/192

(57) ABSTRACT

A lighting element (10) configured to be secured by and in conductive connection with at least two spaced apart AC supply or input terminals (14) of a lighting system, the lighting element (10) has at least one AC LED circuit integrated within the lighting element (10), the at least one AC LED circuit having at least two diodes (12) connected to each other in opposing parallel relation, at least one of which such diodes is an LED (12), first and second AC power input terminals (14) are electrically connected to the at least one AC LED circuit. A thermal conductive material (24) is connected to or formed as part of lighting element (10). The first and second AC power input terminals (14) are configured for removable engagement with the at least two spaced apart AC supply terminals of a lighting system.

### RELATED APPLICATIONS

The present application claims priority to U.S. Provisional Application No. 61/200,999, filed Dec. 5, 2008; and is also related to U.S. Provisional Application No. 61/215,144, filed May 1, 2009—the contents of both of these applications are expressly incorporated herein by reference.

### TECHNICAL FIELD

The present invention generally relates to light emitting diode (“LED”) replacement light bulbs and lighting systems. The present invention more specifically relates to lighting elements incorporating alternating current (“AC”) driven LEDs having a structural design to be used as a replaceable light producing element such as conventional light bulbs used in lighting systems.

### FEDERALLY SPONSORED RESEARCH OR DEVELOPMENT

None.

### BACKGROUND OF THE INVENTION

LEDs are semiconductor devices that produce light when a current is supplied to them. LEDs are intrinsically DC devices that only pass current in one polarity. Historically LED have more commonly been driven by constant current or constant voltage DC. More recently, new inventions have demonstrated that LEDs can be driven with AC.

LEDs can be driven in lighting systems from an AC source if they are connected in an “opposing parallel” configuration according to the inventor of this invention as shown in U.S. Pat. No. 7,489,086 entitled AC light emitting diode and AC LED drive methods and apparatus (“Miskin”). Miskin discloses an AC LED device and lighting system comprising at least one LED and one diode connected together opposing parallel of each other, two opposing parallel LEDs, an opposing parallel LED string and/or opposing parallel LED matrix powered by an AC power source. Miskin discloses a lighting system comprising AC LEDs and drive methods but does not describe an AC LED integrated within a standard bulb

base with AC supply terminals.

Another implementation of an AC LED is a high AC voltage LED lamp as disclosed in U.S. Pat. No. 6,957,899, issued on Oct. 25, 2005, and entitled “Light Emitting Diodes For High AC Voltage Operation and General Lighting”. The '899 patent discloses integrating many individual E-Nitride LEDs onto a single chip or wafer grown, for instance, on an electrically insulating sapphire substrate, with serial interconnection between the LEDs to achieve a single light emitting device, or lamp. Patent '899 discloses a high voltage LED package as a lamp but does not describe an AC LED integrated within a standard bulb base with AC supply terminals. The lamp described in this invention is for printed circuit board implementation.

The increasing adoption of LED technology has resulted in the development of new LED lighting devices and/or elements that replace legacy bulbs. This additionally brings the development of new lighting systems and fixtures that incorporate these LED lighting elements. U.S. Pat. No. 6,971,767 entitled Lighting Element And Lighting Fixture Fitted With Said Element to Ladislav Agabekov (hereinafter “Agabekov”) describes a DC powered lighting system comprising a “lighting element will advantageously have 6 LEDs placed above the plate and 6 LEDs placed below it, each row of 6 LEDs being powered by a 24 volt current, a DC current powering the invention. Agabekov describes a DC powered lighting element solution that requires a DC power source.

The object of this invention is to provide an AC LED lighting element. The lighting element is configured to be secured by and in conductive connection with at least two spaced apart AC supply terminals of a lighting system, the lighting element comprises at least one AC LED circuit integrated within the lighting element. The at least one AC LED circuit having at least two diodes connected to each other in opposing parallel relation, at least one of which such diodes is an LED. First and second AC power input terminals are electrically connected to the AC LED circuit. A thermal conductive material connected to or formed as part of lighting element. The first and second AC power input terminals are configured for removable engagement with the two spaced apart AC supply terminals of a light bulb receptacle within a lighting system.

Another object of the invention is to reduce the cost of materials and assembly of LED technology by integrating multiple elements of the lighting element by utilizing Molded Interconnect Device (MID) Technology. In its most basic form, MID technology can be defined as a process that results in selectively plated plastic parts. This technology is most often used in the three basic ways: one of which includes electromechanical for signal or current carrying traces. MIDs can integrate electrical and mechanical elements into almost any shape of interconnect device.

Another object of this invention is to provide an AC LED lighting system comprising at least one of the lighting elements described in this invention. The AC LED Lighting System comprising at least one AC LED circuit integrated within the at least one lighting element, the at least one AC LED circuit having at least two diodes connected to each other in opposing parallel relation, at least one of which such diodes is an LED. The Lighting element having first and second AC power input terminals electrically connected to the AC LED circuit. A thermal conductive material connected to or formed with the lighting element. The first and second AC power input terminals configured for removable engagement with at the least two spaced apart AC supply terminals of a light bulb receptacle within a lighting system.

A further object of this invention is to provide a fixture for the AC LED lighting element and receptacle that can be fitted with one or more such receptacles and elements.

The term “lighting element” means as used herein an AC LED assembly, module or device that is designed to replace incandescent bulbs, neon tubes, sodium bulbs and/or Xenon bulbs, etc. and powered with an AC power source.

The term “AC supply terminal” means as used herein an electrical socket and/or terminal for a light bulb receptacle in a lighting system.

The term “lighting system” means as used herein a lighting fixture with at least one light bulb socket, a track or linear lighting system comprising at least one light bulb fixture or light bulb socket.

The term “AC power input terminals” means as used herein terminals designed to be electrically inserted and removable from an AC supply terminal of a light bulb receptacle within a lighting system.

The term Molded Interconnect Device (MID) Technology means as used herein, in its most basic form, MID technology can be defined as a process that results in selectively plated plastic parts.

The present invention addresses the above-noted shortcomings of the prior art while providing additional benefits and advantages.

### SUMMARY OF THE INVENTION

According to one broad aspect of the invention a lighting element is provided having one or more AC powered LED circuits. Each LED circuit within the lighting element can comprise a packaged AC LED and/or an assembly of LEDs configured into an AC LED circuit within the lighting element.

Another aspect of the invention is to provide a lighting system suitable for utilizing the lighting element as light bulb replacement light source.

The definition of an AC LED lighting element according to this invention comprises an AC LED or AC LED assembly and conductive bulb type terminals. The AC LED lighting element may be connected to or formed with a heat sink.

The definition of printed circuit board as used throughout this invention includes metalized circuit traces and/or metalized component pads on circuit board.

The definition of AC LED printed circuit according to this invention includes metalized circuit traces and/or metalized component pads on the lighting element surface either with or without a dielectric layer between the printed circuit and the lighting element. The printed circuit being conductively connected to the AC power input terminals of the lighting element.

The definition of an AC LED circuit according to this invention comprises (i.) a LED circuit that has at least two diodes connected to each other in opposing parallel relation, at least one of which such diodes is an LED, (ii.) The AC LED circuit may be LED semiconductors configured into an AC LED circuit and integrated within a single LED package that would provide at least two contact pads or terminals or, prepackaged LEDs that can be configured into an AC LED circuit within a printed circuit board “PCB.”

The AC LED lighting element can be connected to a receptacle design to fit the LED lighting element and the receptacle may be designed to fit a linear lighting or track type fixture. Some linear lighting systems may already include receptacles that would match the AC LED lighting element therefore the element would provide a LED retrofit light source for the existing system.

According to another aspect of the invention LED circuit (sometimes referred to as an “AC LED”) can comprise two opposing parallel LEDs, an opposing parallel LED string or an opposing parallel LED matrix having a capacitor in series to at least one junction of the connected opposing parallel configurations within a single chip, a single package, an assembly or a module.

### BRIEF DESCRIPTION OF THE DRAWINGS

FIG. 1 shows a schematic view of a preferred embodiment of the invention;

FIG. 2 shows a schematic view of a preferred embodiment of the invention;

FIG. 3 shows a schematic view of a preferred embodiment of the invention;

FIG. 4 shows a schematic view of a preferred embodiment of the invention;

FIG. 5 shows a schematic view of a preferred embodiment of the invention;

FIG. 6 shows a schematic view of a preferred embodiment of the invention;

FIG. 7 shows a schematic view of a preferred embodiment of the invention;

FIG. 8 shows a schematic view of a preferred embodiment of the invention;

FIG. 9 shows a schematic view of a preferred embodiment of the invention; and,

FIG. 10 shows a schematic view of a preferred embodiment of the invention;

### DETAILED DESCRIPTION OF PREFERRED EMBODIMENTS

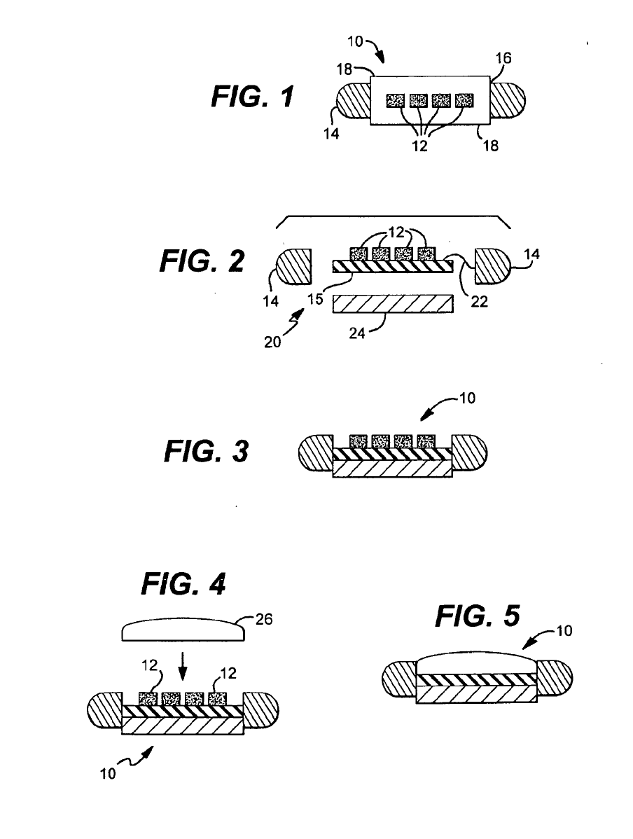

FIG. 1 discloses a top view schematic diagram of a lighting element 10 according to the invention. The lighting element 10 includes LEDs 12 configured into anti-parallel AC LED circuits mounted on a printed circuit on the lighting element 10. The lighting element includes two spaced apart AC power input terminals 14 for temporary attachment with the at least two spaced apart AC supply terminals of a light bulb receptacle within a lighting system. The AC power input terminals 14 are isolated from each other electrically with the AC LED circuit being connected between the two AC power input terminals 14. A thermal conductive material may be connected to or formed as part of the outer surface of the lighting element 18. A dielectric material may be placed between the point 16 where the AC power input terminals 14 and the thermal conductive material may join. The LEDs 12 may be (i.) single chip AC LEDs comprising the AC LED circuit within each individual LED 12, (ii.) individual chips on a substrate configured into an AC LED circuit and packaged within each individual LED 12, (iii.) or discrete LEDs 12 where each LED 12 is used collectively to make up the entire AC LED circuit.

FIG. 2 discloses a side view schematic diagram of the individual components 20 that the lighting element 10 described in FIG. 1 above can comprise in one embodiment. The LEDs 12 are mounted on a printed circuit board 15 and electrically connected to the AC power input terminals 14 via a wire 22 or directly to a conductive point on the printed circuit board 15. The printed circuit board 15 may be mounted to a thermal conductive material 24 for heat sinking the LEDs 12. The lighting element may include a lens or an optic.

FIG. 3 discloses a side view schematic diagram of the assembled lighting element 10 without a lens or optic as described in FIGS. 1 and 2.

FIG. 4 discloses a schematic diagram of the lighting element 10 according to the invention and a lens or optic 26 that would cover the LEDs 12 and provide optical control of the light output from the lighting element 10. The lens 26 may be tinted as well to provide a method of converting the color of light, the color temperature of light and potentially the color rendering index of light emitted from the LEDs 12.

FIG. 5 discloses a side view schematic diagram of the lighting element 10 according to the invention with the lens 26 mounted to the lighting element 10.

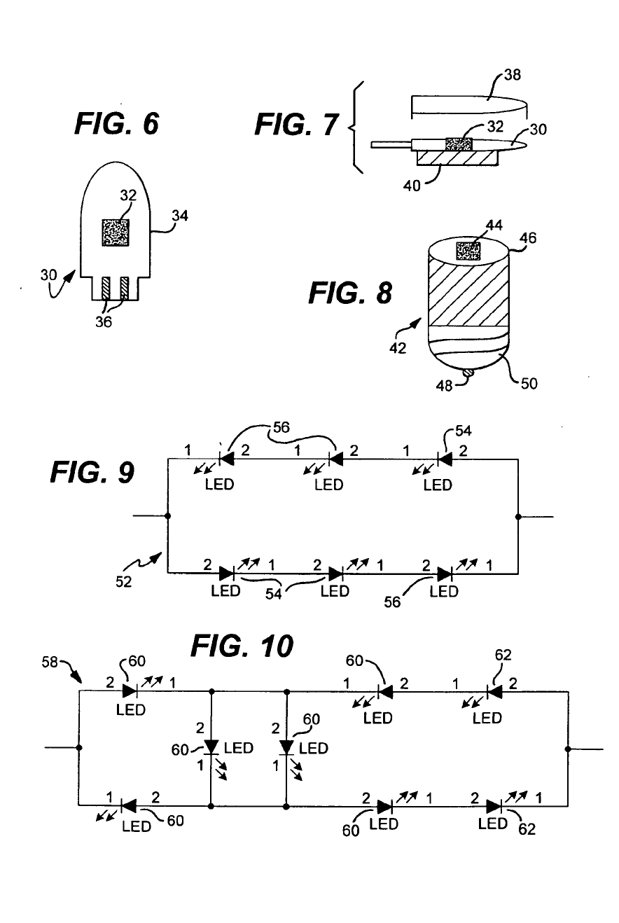

FIG. 6 discloses a top view schematic diagram of a lighting element 30 according to the invention. The lighting element 30 includes LEDs 32 configured into anti-parallel AC LED circuits mounted on a printed circuit board 34. The lighting element 30 printed circuit board 34 includes two spaced apart AC power input terminals 36 for temporary attachment with the at least two spaced apart AC supply terminals of a light bulb receptacle within a lighting system. The AC power input terminals 36 are isolated from each other electrically with the AC LED circuit being connected between the two AC power input terminals 36. A thermal conductive material may be connected to or formed as part of the outer surface of the lighting element 30. The LEDs 32 may be (i.) single chip AC LEDs comprising the AC LED circuit within each individual LED 32, (ii.) individual chips on a substrate configured into an AC LED circuit and packaged within each individual LED 32, (iii.) or discrete LEDs 32 where each LED 32 is used collectively to make up the entire AC LED circuit.

FIG. 7 discloses a schematic diagram of the lighting element 30 according to the invention and a lens or optic 38 that would cover the LEDs 32 and provide optical control of the light output from the lighting element 30. The lens 38 may be tinted as well to provide a method of converting the color of light, the color temperature of light and potentially the color rendering index of light emitted from the LEDs 32. The lighting element 30 in this embodiment includes a thermal conductive material 40 connected to and/or formed on the lighting element 30 for heat sinking the LEDs 32

FIG. 8 discloses a top view schematic diagram of a lighting element 42 according to the invention. The lighting element 42 includes LEDs 44 configured into anti-parallel AC LED circuits mounted on a printed circuit. The lighting element 42 includes a thermal conductive material 46 for heat sinking and two spaced apart AC power input terminals 48 and 50 for temporary attachment with the at least two spaced apart AC supply terminals of a light bulb receptacle within a lighting system. The LEDs 44 may be (i.) single chip AC LEDs comprising the AC LED circuit within each individual LED 44, (ii.) individual chips on a substrate configured into an AC LED circuit and packaged within each individual LED 44, (iii.) or discrete LEDs 44 where each LED 44 is used collectively to make up the entire AC LED circuit.

FIG. 9 discloses a schematic diagram of one AC LED circuit 52 according to the invention. The AC LED circuit comprises at least 2 LEDs 54 connected to each other in opposing parallel relation and the LEDs 54 may include additional LEDs 56 connected in series to the first 2 LEDs 54 thereby increasing the voltage range of the AC LED circuit 52.

FIG. 10 discloses a schematic diagram of another AC LED circuit 58 according to the invention. The AC LED circuit comprises at least 6 LEDs 60 connected to each other in a bridge circuit and may include additional LEDs 62 within the AC LED circuit 58 to provide an imbalanced bridge circuit.

What is claimed is:

1. A lighting element configured to be secured by and in conductive connection with at least two spaced apart AC supply terminals of a lighting system, the lighting element comprising:
at least one AC LED circuit integrated within the lighting element,
the at least one AC LED circuit having
at least two diodes connected to each other in opposing parallel relation, at least one of which such diodes is an LED,
first and second AC power input terminals electrically connected to the at least one AC LED circuit,
a thermal conductive material connected to or formed as part of lighting element the first and second AC power input terminals configured for removable engagement with the at least two spaced apart AC supply terminals of a light bulb receptacle within a lighting system.

2. The lighting element of claim 1, wherein the at least one AC LED circuit including at least one device for limiting current through the LEDs.

3. The lighting element of claim 1 being formed with selectively plated plastics.

4. The lighting element claim 3 wherein the electrical circuit conductive traces and pads for the at least one AC LED circuit being formed with the plating of selectively plated plastics.

5. The lighting element of claim 1 wherein the at least one AC LED circuit being integrated within a single chip and integrated within the lighting element.

6. The lighting element claim 1 wherein the at least one AC LED circuit being made with discrete LEDs and integrated within the lighting element.

7. The lighting element of claim 1 wherein the at least one AC LED circuit being integrated within a packaged AC LED and integrated within the lighting element.

8. The lighting element of claim 1 further comprising a lens cover.

9. The lighting element of claim 1 further comprising a light distribution beam shaping lens.

10. The lighting element of claim 1 further comprising a light distribution range between approximately 5 and approximately 360 degrees.

11. The lighting element of claim 1 wherein the AC LED circuit includes a bridge circuit made with LEDs.

12. The lighting element of claim 1 wherein the AC LED circuit includes an imbalanced bridge circuit made with LEDs

13. A lighting system comprising:
at least one lighting element configured to be secured by and in conductive connection with at least two spaced apart AC supply terminals of a lighting system, the at least one lighting element further comprising:
at least one AC LED circuit integrated within the lighting element,
the at least one AC LED circuit having at least two diodes connected to each other in opposing parallel relation, at least one of which such diodes is an LED,
first and second AC power input terminals electrically connected to the at least one AC LED circuit,
a thermal conductive material connected to or formed with the lighting element the first and second AC power input terminals configured for removable engagement with the at least two spaced apart AC supply terminals of a light bulb receptacle socket within a lighting system.

14. The lighting system of claim 13, wherein the at least one AC LED circuit includes at least one device for limiting current through the LEDs.

15. The lighting system of claim 13, wherein the lighting element being formed with selectively plated plastics.

16. The lighting system of claim 15, wherein the at least one AC LED circuit being formed with selectively plated plastics.

17. The lighting system of claim 13, wherein the at least one AC LED circuit being integrated within a single chip and integrated within the lighting element.

18. The lighting system of claim 13, wherein the at least one AC LED circuit being made with discrete LEDs and integrated within the lighting element.

19. The lighting system of claim 13, wherein the at least one AC LED circuit being integrated within a packaged AC LED and integrated within the lighting element.
